(19) United States
(12) Patent Application Publication
(10) Pub. No.: US 2025/0199297 A1
(43) Pub. Date: Jun. 19, 2025

(54) OPTICAL DEVICE AND IMAGING UNIT PROVIDED WITH OPTICAL DEVICE

(71) Applicant: Murata Manufacturing Co., Ltd., Nagaokakyo-shi (JP)

(72) Inventors: Hitoshi SAKAGUCHI, Nagaokakyo-shi (JP); Yuuki ISHII, Nagaokakyo-shi (JP); Noritaka KISHI, Nagaokakyo-shi (JP)

(21) Appl. No.: 19/072,434

(22) Filed: Mar. 6, 2025

Related U.S. Application Data
(63) Continuation of application No. PCT/JP2023/019271, filed on May 24, 2023.

(30) Foreign Application Priority Data
Oct. 19, 2022 (JP) 2022-167674

(51) Int. Cl. G02B 27/00; H04N 23/52

(52) U.S. Cl. CPC G02B 27/0006; H04N 23/52

(57) ABSTRACT

The present disclosure provides an optical device that can be miniaturized and a manufacturing cost of which can be reduced, and an imaging unit provided with the optical device. The optical device includes: an outermost layer lens (light transmitting body) which transmits light having a predetermined wavelength; a housing which holds the outermost layer lens; a vibrating body which is in contact with the outermost layer lens held by the housing; and a piezoelectric element which is provided on the vibrating body and vibrates the vibrating body. The vibrating body is a tubular body and has a shape which has a plurality of groove portions in a supporting portion (third portion), the supporting portion connecting a connecting portion (first portion) which is in contact with the outermost layer lens and a vibrating portion (second portion) on which the piezoelectric element is provided.

### CROSS REFERENCE TO RELATED APPLICATIONS

This application is a continuation of International Application No. PCT/JP2023/019271, filed May 24, 2023, which claims priority to Japanese Patent Application No. 2022-167674, filed Oct. 19, 2022, the contents of each of which are hereby incorporated by reference in their entirety.

### TECHNICAL FIELD

The present disclosure relates to an optical device and an imaging unit provided with the optical device.

### BACKGROUND

A safety device of a vehicle is controlled and driving support control is performed using an image obtained by an imaging unit which is provided in a front portion or a rear portion of the vehicle. Such an imaging unit is often provided on an outer side portion of a vehicle, and therefore foreign matters such as raindrops (water droplets), mud, and dusts sometimes adhere to a light transmitting body (a protection cover or a lens) covering the outer portion thereof. When a foreign matter adheres to a light transmitting body, the foreign matter is reflected in an image obtained by a corresponding imaging unit and a clear image cannot be obtained. In view of this, for example, Japanese Patent No. 6819844 (the “'844 Patent), an imaging unit is provided with a vibrating device which vibrates a light transmitting body to remove foreign matters adhering to the surface of the light transmitting body.

In the imaging unit described in the '844 Patent, foreign matters adhering to the surface of the light transmitting body are removed by vibrating the light transmitting body with a vibrating device including the light transmitting body, a first tubular body, a spring portion, a second tubular body, and a vibrating body. However, in the imaging unit described the '844 Patent, the vibrating device that vibrates the light transmitting body has a three-dimensional spring structure in which the first tubular body is provided on the second tubular body with the spring portion interposed therebetween. Therefore, the size is likely to be increased, and the shape is complicated, the processing accordingly takes time, and the manufacturing cost is increased.

### SUMMARY OF INVENTION

In view of the above, an object of the present disclosure is to provide an optical device that can be miniaturized and a manufacturing cost of which can be reduced, and an imaging unit provided with the optical device.

In some aspects, the techniques described herein relate to an optical device including: a light transmitting body configured to transmit light within a predetermined wavelength; a housing configured to hold the light transmitting body; a vibrating body in contact with the light transmitting body and held by the housing; and a piezoelectric element provided on the vibrating body and configured to vibrate the vibrating body; wherein the vibrating body is a tubular body and including a shape with a plurality of groove portions in a third portion, the third portion connecting a first portion which is in contact with the light transmitting body and a second portion on which the piezoelectric element is provided.

In some aspects, the techniques described herein relate to an imaging unit including: a light transmitting body configured to transmit light within a predetermined wavelength; a housing configured to hold the light transmitting body; a vibrating body in contact with the light transmitting body and held by the housing; a piezoelectric element provided on the vibrating body and configured to vibrate the vibrating body; and an imaging element arranged wherein the light transmitting body is in a viewing direction thereof; wherein the vibrating body is a tubular body and including a shape with a plurality of groove portions in a third portion, the third portion connecting a first portion which is in contact with the light transmitting body and a second portion on which the piezoelectric element is provided.

According to the present disclosure, the vibrating body is a tubular body and has a shape having a plurality of groove portions in the third portion connecting the first portion, which is in contact with the light transmitting body, and the second portion, on which the piezoelectric element is provided, and thus it is possible to miniaturize the optical device and the imaging unit including the optical device, and to reduce the manufacturing cost.

### BRIEF DESCRIPTION OF DRAWINGS

In the descriptions that follow, like parts are marked throughout the specification and drawings with the same numerals, respectively. The drawings are not necessarily drawn to scale and certain drawings may be illustrated in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is a schematic view of an imaging unit in accordance with aspects of the present disclosure;

FIG. 2 is a sectional view of the imaging unit in accordance with aspects of the present disclosure;

FIG. 3A and FIG. 3B are schematic views of a vibrating body in accordance with aspects of the present disclosure;

FIG. 4A and FIG. 4B are diagrams illustrating deformation generated when the vibrating body is vibrated in accordance with aspects of the present disclosure;

FIG. 5 is a diagram illustrating a sound pressure distribution obtained when the vibrating body is vibrated in accordance with aspects of the present disclosure;

FIG. 6 is a diagram illustrating a heat distribution obtained when the vibrating body is vibrated in accordance with aspects of the present disclosure;

FIG. 7 is a schematic view of a modification of the vibrating body in accordance with aspects of the present disclosure;

FIG. 8 is a schematic view of another modification of the vibrating body in accordance with aspects of the present disclosure;

FIG. 9A and FIG. 9B are schematic views of a vibrating body in accordance with aspects of the present disclosure;

FIG. 10 is a graph showing a comparison of stresses between vibrating bodies in accordance with aspects of the present disclosure;

FIG. 11A and FIG. 11B are schematic views of a vibrating body in accordance with aspects of the present disclosure;

FIG. 12A and FIG. 12B are schematic views of a vibrating body in accordance with aspects of the present disclosure; and

FIG. 13 is a schematic view of a vibrating body in accordance with aspects of the present disclosure.

### DETAILED DESCRIPTION

Hereinbelow, aspects of the present disclosure will be described. In a following description of the drawings, the same or similar components will be represented with use of the same or similar reference characters. The drawings are exemplary, sizes or shapes of portions are schematic, and technical scope of the present disclosure should not be understood with limitation to the aspects.

Hereinafter, an optical device and an imaging unit provided with the optical device according to aspects of the present disclosure will be described in detail with reference to the drawings. In the drawings, the same reference characters denote the same or corresponding portions. The optical device described below is applied to, for example, an in-vehicle imaging unit, and a vibrating a light transmitting body (for example, an outermost layer lens) to remove a foreign matter adhering to the surface of the light transmitting body. The optical device is not limitedly applied to an in-vehicle imaging unit. For example, the optical device can also be applied to a security monitoring camera, an imaging unit for a drone, and the like.

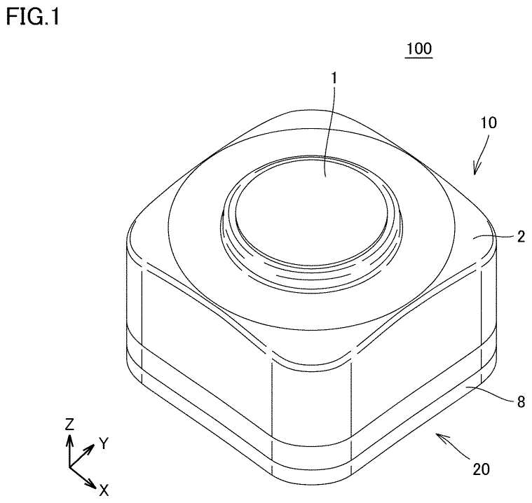

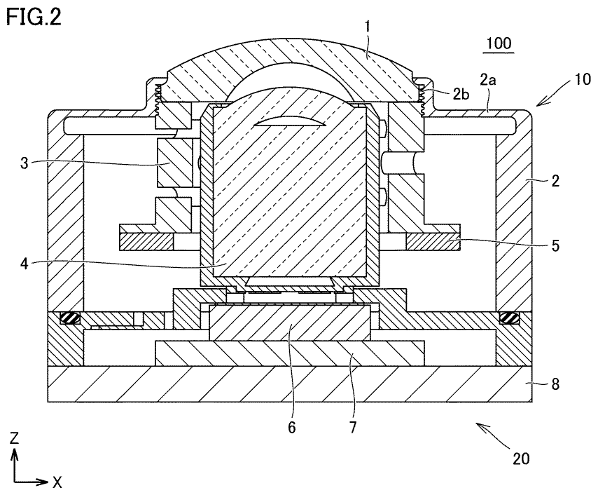

FIG. 1 is a schematic view of an imaging unit 100 according to an aspect of the present disclosure. FIG. 2 is a sectional view of the imaging unit 100 according to an aspect of the present disclosure. Note that X, Y, and Z directions in the drawings respectively indicate a lateral direction, a depth direction, and a height direction of the imaging unit 100. The imaging unit 100 includes an optical device 10 and an imaging device 20. The optical device 10 includes an outermost layer lens 1, a housing 2, a vibrating body 3, an inner layer lens 4, and a piezoelectric element 5. The imaging device 20 includes an imaging element 6, a circuit board 7, and a case 8.

After alignment adjustment between the outermost layer lens 1 and the inner layer lens 4 is performed, the imaging device 20 including the imaging element 6 is combined with the optical device 10, thereby forming the imaging unit 100. In an aspect of the present disclosure, the optical device 10 is described as having the configuration including the inner layer lens 4, but the inner layer lens 4 may be provided to the imaging device 20. The imaging unit 100 may include at least the optical device 10 and the imaging element 6 which is arranged such that the outermost layer lens 1 and the inner layer lens 4 are in the viewing direction thereof.

The imaging element 6 is, for example, an image sensor such as a charge coupled device (CCD) and a complementary metal-oxide-semiconductor (CMOS) sensor, and is mounted on the circuit board 7. On the circuit board 7, not only a semiconductor element such as a general-purpose integrated circuit (IC) or application specific integrated circuit (ASIC) for controlling the imaging element 6 but also, for example, a semiconductor element for generating a signal for driving the piezoelectric element 5 may be mounted. The circuit board 7 is fixed to the case 8 at a position where the alignment between the outermost layer lens 1 and inner layer lens 4 and the imaging element 6 is adjusted.

The outermost layer lens 1 is a light transmitting body that transmits light having a predetermined wavelength (for example, a wavelength of visible light, a wavelength that can be captured by an imaging element, or the like), and is, for example, a convex meniscus lens. The optical device 10 may employ a transparent member such as a protection cover instead of the outermost layer lens 1. The protection cover is made of glass or resin such as transparent plastics.

An end portion of the outermost layer lens 1 is held by an end portion of a plate spring 2a extending from the housing 2. A space between the outermost layer lens 1 and a retainer 2b, which is an end portion of the plate spring 2a, is filled with an adhesive. Further, in the optical device 10, the vibrating body 3 is provided at a position which is in contact with the outermost layer lens 1 to vibrate the outermost layer lens 1 held by the housing 2.

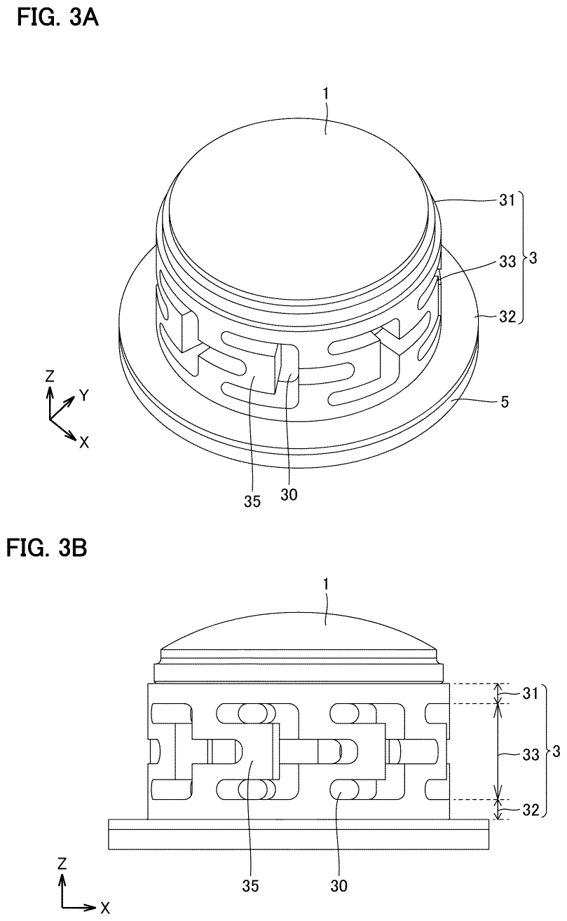

FIG. 3A and FIG. 3B are schematic views of the vibrating body 3 according to an aspect of the present disclosure. FIG. 3A is a perspective view of the vibrating body 3, and FIG. 3B is a side view of the vibrating body 3. The vibrating body 3 is a tubular body as shown in FIG. 3A. In addition, as shown in FIG. 3B, the vibrating body 3 includes a connecting portion 31 (first portion) which is in contact with the outermost layer lens 1, a vibrating portion 32 (second portion) on which the piezoelectric element 5 is provided, and a supporting portion 33 (third portion) which connects the connecting portion 31 and the vibrating portion 32. The connecting portion 31, the vibrating portion 32, and the supporting portion 33 may be formed integrally or separately.

The connecting portion 31 is a portion which comes into contact with the outermost layer lens 1, and has a cylindrical shape which is extended in the axial direction (Z direction) of the tubular body. The vibrating portion 32 is a portion which vibrates along with the vibration of the piezoelectric element 5, and has a flange portion in the radial direction of the vibrating body 3 so that the piezoelectric element 5 can be easily provided thereon. The supporting portion 33 is a side surface portion of the vibrating body 3, and a plurality of groove portions 30 each having a horizontally-laid Y shape (tuning fork shape) are formed side by side at equal intervals in the circumferential direction of the vibrating body 3. The groove portion 30 penetrates the supporting portion 33 and is a cavity penetrating in the radial direction of the vibrating body 3.

The groove portion 30 has the horizontally-laid Y shape (tuning fork shape), and has a shape which is line-symmetrical with respect to the radial direction of the vibrating body 3. The groove portion 30 is formed such that one end portion thereof is in contact with the connecting portion 31 and the other end portion thereof is in contact with the vibrating portion 32. The portions of the supporting portion 33 left by forming the groove portions 30 serve as a plurality of columns 35 each of which has a U shape and connects the connecting portion 31 and the vibrating portion 32. The columns 35 function as a spring which vibrates the outermost layer lens 1 in the Z direction.

The column 35 has a horizontally-laid U shape. As shown in FIG. 3B, the column 35 has a shape in which a portion connected with the connecting portion 31 and a portion connected with the vibrating portion 32 are arranged substantially on a straight line. Accordingly, the vibrating body 3 can vibrate the outermost layer lens 1 in the Z direction by the U-shaped portions of the columns 35 being narrowed or widened by the vibration of the piezoelectric element 5.

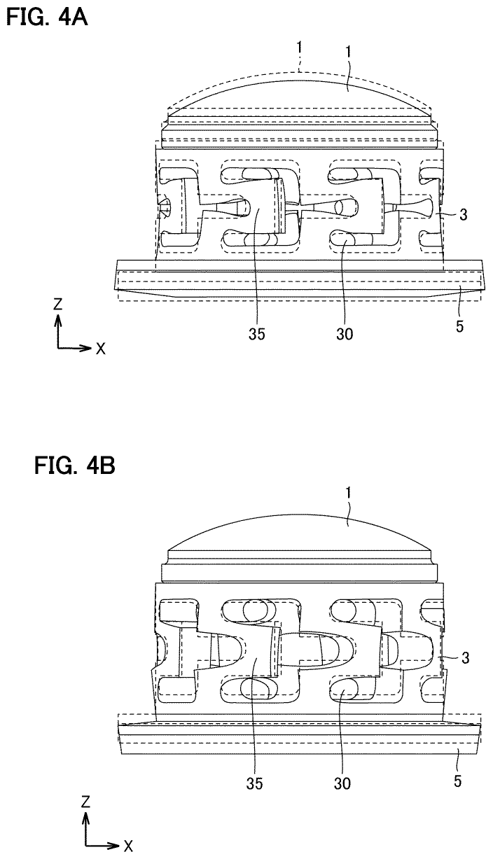

FIG. 4A and FIG. 4B are diagrams illustrating deformation generated when the vibrating body 3 according to an aspect is vibrated. In FIG. 4A, the U-shaped portions of the columns 35 are narrowed by the vibration of the piezoelectric element 5 and the outermost layer lens 1 is deformed to the lower side in the drawing (the negative side in the Z direction). Alternatively, in FIG. 4B, the U-shaped portions of the columns 35 are widened by the vibration of the piezoelectric element 5 and the outermost layer lens 1 is deformed to the upper side in the drawing (the positive side in the Z direction). The vibrating body 3 repeats the deformation shown in FIG. 4A and the deformation shown in FIG. 4B to vibrate the entire outermost layer lens 1 in the Z direction, thereby being able to remove foreign matters adhering to the surface of the outermost layer lens 1.

The piezoelectric element 5 is provided on a surface of the vibrating portion 32 on a side opposite to a side in contact with the outermost layer lens 1. The piezoelectric element 5 has a hollow circular shape and vibrates by being polarized in the thickness direction, for example. The piezoelectric element 5 is made of PZT-based piezoelectric ceramics. However, other piezoelectric ceramics such as (K, Na) NbO₃ may be used. Further, a piezoelectric single crystal such as LiTaO₃ may be used.

The piezoelectric element 5 having the hollow circular shape vibrates in the radial direction and the vibration is converted into vibration in the Z direction (vertical direction in the drawing) by the supporting portion 33 of the vibrating body 3, whereby the outermost layer lens 1 vibrates in the Z direction. As illustrated in FIG. 4A and FIG. 4B, the vibrating body 3 displaces the outermost layer lens 1 in the Z direction by the plurality of columns 35 of the supporting portion 33 being elastically deformed like a spring. The vibration of the vibrating body 3 also elastically deforms the plate spring 2a of the housing 2 which holds the outermost layer lens 1.

In the optical device 10, the groove portions 30 are formed in the side surface (supporting portion 33) in the Z direction of the vibrating body 3, and thus the spring (columns 35) which stretches and contracts in the Z direction can be formed. Therefore, the optical device 10 can be reduced in volume to be miniaturized as compared with an optical device in which an outermost layer lens is vibrated by using a two dimensional plate spring extending in the XY direction. Further, in the optical device 10, the vibrating body 3 is a simple tubular body and can be formed by only forming the groove portions 30 on the side surface thereof, and therefore, the manufacturing cost can be reduced.

In the vibrating body 3, for example, eight groove portions 30 are formed in a side surface (supporting portion 33) of a cylindrical body, which is made of SUS420J2 and has a 15 mm diameter, to form eight columns 35 each having a U shape. The piezoelectric element 5 having a size of outer diameter 19 mm (inner diameter 13 mm)×thickness 1.0 mm is provided on the bottom surface (vibrating portion 32) of the vibrating body 3. The upper surface (connecting portion 31) of the vibrating body 3 is in contact with the outermost layer lens 1 which is made of glass and has a size of diameter 14.4 mm×thickness 3.5 mm. When a simulation was performed in which the outermost layer lens 1 was vibrated by inputting 20 Vp-p as the voltage Vp-p into the piezoelectric element 5 in the optical device 10 having the above-described vibrating body 3, the resonant frequency was 26.6 kHz, the resonance resistance was 302.6 Q, and the maximum displacement amount was 9.8 μm, which showed that the required vibration performance can be obtained. The voltage Vp-p inputted into the piezoelectric element 5 is not limited to 20 Vp-p but may be, for example, approximately 40 Vp-p to 60 Vp-p. The maximum deformation amount at this time is 20.0 μm or more. Here, the voltage Vp-p is a voltage of a difference between a maximum value (+Vpp) and a minimum value (−Vpp) of a drive signal (alternating current signal) (a peak-to-peak value).

The product size of the optical device 10 can be significantly reduced compared to an optical device having a configuration (configuration of a comparison object) including a first tubular body, a spring portion, and a second tubular body, and in particular, can be reduced by approximately 33% in the radial direction. The product size of the imaging unit 100 depends on the size in the radial direction in the product size of the optical device 10, and therefore, the product size of the imaging unit 100 can be reduced by employing the configuration of the optical device 10. The volume of the tubular body of the vibrating body 3 is substantially half the volume of the vibrating body of the comparison object.

The vibrating body of the comparison object employs the configuration in which a lens, an imaging element, and the like are arranged inside the first tubular body and the second tubular body to cover the periphery thereof, therefore, air compressed by vibration of a light transmitting body cannot be released to the outside and the vibration of the light transmitting body may be accordingly damped. Further, heat generated from the imaging element or the like cannot be released to the outside and accordingly, the heat is easily accumulated inside the first tubular body and the second tubular body.

Alternatively, in the optical device 10, the groove portions 30 are formed in the side surface (the supporting portion 33) in the Z direction of the vibrating body 3, and the inside and the outside of the vibrating body 3 which is a tubular body are accordingly connected to each other via the groove portions 30 (cavities). Therefore, in the optical device 10, air compressed by the vibration of the light transmitting body can be released to the outside, and the damping of the vibration of the outermost layer lens 1 can be reduced.

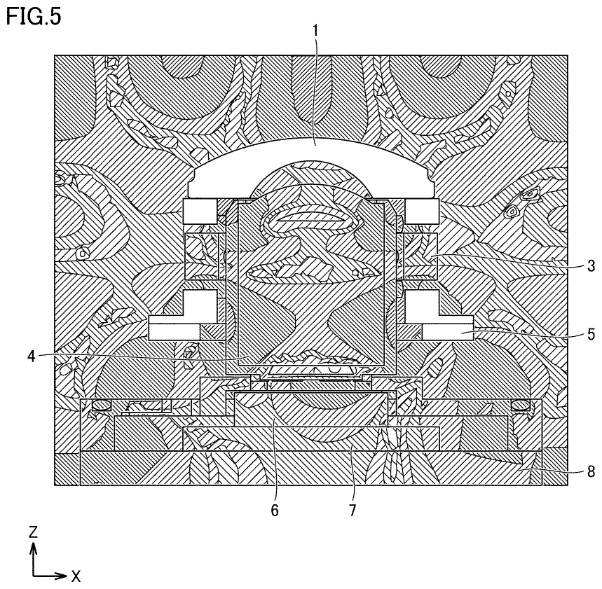

Air compressed by vibration can be measured based on sound pressure. FIG. 5 is a diagram illustrating a sound pressure distribution obtained when the vibrating body 3 according to an aspect is vibrated. In the vibrating body of the comparison object, the air between the light transmitting body and the inner layer lens is compressed by vibrating the first tubular body and the light transmitting body in the Z direction, increasing the sound pressure. When the sound pressure in this portion increases, the vibration of the light transmitting body is damped. However, in the optical device 10, even when the outermost layer lens 1 is vibrated in the Z direction, the air between the outermost layer lens 1 and the inner layer lens 4 can be released to the outside from the groove portions 30 of the side surface (supporting portion 33) of the vibrating body 3, and thus the sound pressure of the corresponding portion can be reduced as illustrated in FIG. 5. Specifically, the sound pressure between the outermost layer lens 1 and the inner layer lens 4 does not increase and therefore, the damping of the vibration of the outermost layer lens 1 can be reduced. As illustrated in FIG. 5, the magnitude of the sound pressure is indicated by the shading of hatching and a dark hatching portion indicates a portion where the sound pressure is high, and the sound pressure is high outside the outermost layer lens 1, for example.

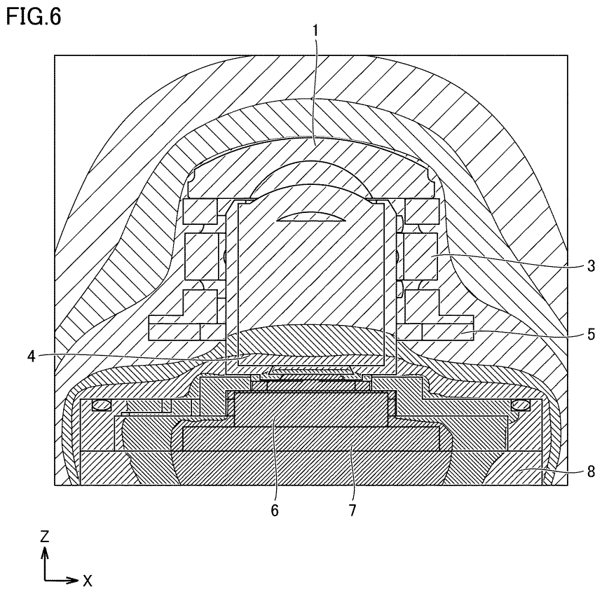

FIG. 6 is a diagram illustrating a heat distribution obtained when the vibrating body 3 according to an aspect is vibrated. FIG. 6 shows the result of simulating the thermal distribution obtained when 1 W power was applied to the imaging element 6. The result shown in FIG. 6 illustrates the temperature distribution of the optical device 10 after elapse of a predetermined period (for example, 1000 sec) from the start of the operation of the imaging element 6 to obtain a thermally balanced state of the heat generated in the imaging element 6. As shown in FIG. 6, the optical device 10 exhibits a heat dissipation effect making it possible to suppress a temperature rise inside the vibrating body 3, which is a tubular body, to be low by releasing heat generated from the imaging element 6 to the outside from the groove portions 30. In FIG. 6, the level of the temperature is indicated by the shading of hatching and a dark hatching portion indicates a portion where the temperature is high, and the temperature is high in the vicinity of the imaging element 6.

As illustrated in FIG. 3A and FIG. 3B, the vibrating body 3 has the eight groove portions 30 formed in the side surface (supporting portion 33) thereof to form the eight U-shaped columns 35. However, the vibrating body 3 is not limited to this configuration, and the groove portion 30 having a horizontally-laid Y shape may be enlarged in the circumferential direction.

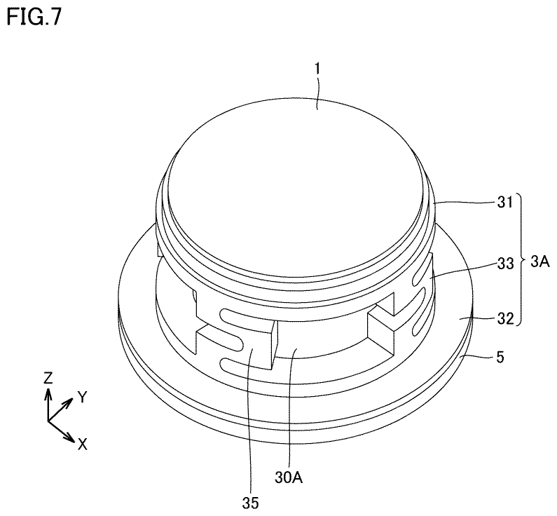

FIG. 7 is a schematic view of a modification of the vibrating body 3 according to an aspect of the present disclosure. In a vibrating body 3A, four groove portions 30A enlarged in the circumferential direction as shown in FIG. 7 are formed in the side surface (supporting portion 33) and four U-shaped columns 35 are formed. Specifically, in the vibrating body 3A, the groove portions 30A having a larger volume than the groove portions 30 are formed in the side surface (supporting portion 33) of the vibrating body 3A. Specifically, the thickness of the column 35 in the vibrating body 3A is the same or roughly the same as the thickness of the column 35 in the vibrating body 3, but may be different from the same. In the vibrating bodies 3 and 3A, the plurality of groove portions 30 and 30A are provided at equal intervals in the circumferential direction of the side surfaces (supporting portions 33), but may be formed at different intervals. Further, in the vibrating bodies 3 and 3A, the shape of the column 35 is not limited to the U shape but may be a shape in which columns having a horizontally-laid U shape are stacked in the Z direction.

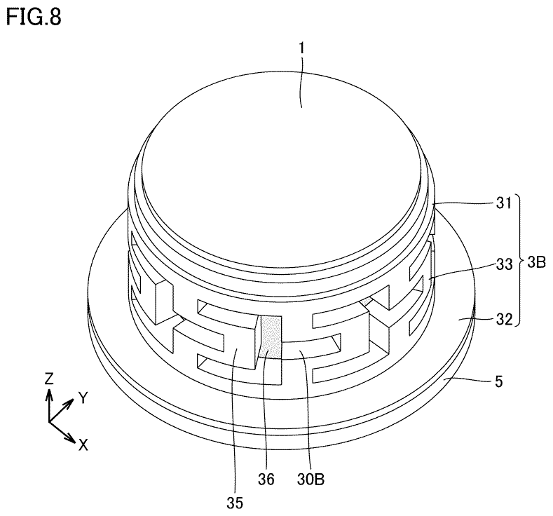

The groove portion 30 penetrates the supporting portion 33 and is a cavity penetrating in the radial direction of the vibrating body 3, as described in FIG. 3A and FIG. 3B. However, the groove portion 30 is not limited to a cavity but may be a concave portion which does not penetrate the supporting portion 33. FIG. 8 is a schematic view of another modification of the vibrating body 3 according to an aspect of the present disclosure. In vibrating body 3B, as shown in FIG. 8, a plurality of groove portions 30B each having a horizontally-laid Y shape are formed side by side at equal intervals in the circumferential direction of the vibrating body 3B. The groove portion 30B does not penetrate the supporting portion 33 and is a concave portion which has a bottom surface 36 in the radial direction of the vibrating body 3B. Specifically, the vibrating body 3B has a configuration in which a plurality of columns 35 are connected to each other on the bottom surface 36. The position of the bottom surface 36 is not limited to the inner side of the vibrating body 3B but may be provided on the outer side of the vibrating body 3B. Further, one or more through holes may be formed in the bottom surface 36 of the groove portion 30B.

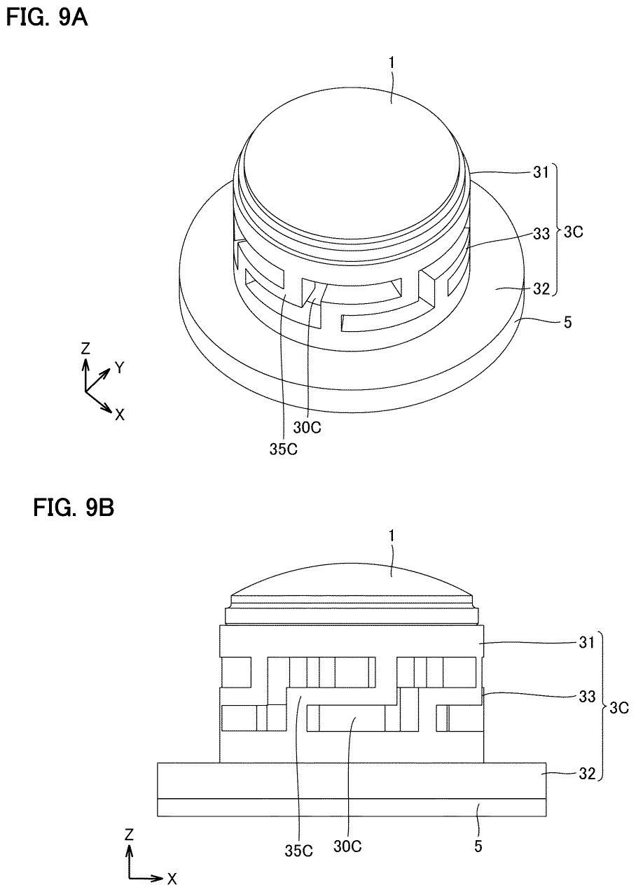

The vibrating body 3 according to an aspect described above as having the plurality of U-shaped columns 35 which connect the connecting portion 31 and the vibrating portion 32 as shown in FIG. 3A and FIG. 3B. In an aspect, a vibrating body having a column of a different shape from the U shape will be described. FIG. 9A and FIG. 9B are a schematic view of a vibrating body 3C according to an aspect of the present disclosure. Note, the optical device 10 having the vibrating body 3C and the imaging unit 100 including the optical device 10 have the same configurations as those described above, and therefore, the same configurations will be described with the same reference characters and the detailed description thereof will not be repeated.

FIG. 9A is a perspective view of the vibrating body 3C, and FIG. 9B is a side view of the vibrating body 3C. The vibrating body 3C is a tubular body as shown in FIG. 9A. In addition, as shown in FIG. 9B, the vibrating body 3C includes the connecting portion 31 (first portion) which is in contact with the outermost layer lens 1, the vibrating portion 32 (second portion) on which the piezoelectric element 5 is provided, and the supporting portion 33 (third portion) which connects the connecting portion 31 and the vibrating portion 32.

In the supporting portion 33, a plurality of groove portions 30C each having a stepped shape are formed side by side at equal intervals in the circumferential direction of the vibrating body 3C. The groove portion 30C penetrates the supporting portion 33 and is a cavity penetrating in the radial direction of the vibrating body 3C.

The groove portion 30C has the stepped shape and a point-symmetrical shape. The groove portion 30C is formed such that one end portion thereof is in contact with the connecting portion 31 and the other end portion thereof is in contact with the vibrating portion 32. The portions of the supporting portion 33 left by forming the groove portions 30C serve as a plurality of columns 35C each of which has a cantilever shape and connects the connecting portion 31 and the vibrating portion 32. The columns 35C function as a spring which vibrates the outermost layer lens 1 in the Z direction. The groove portion 30C is not limited to a cavity but may be a concave portion which does not penetrate the supporting portion 33.

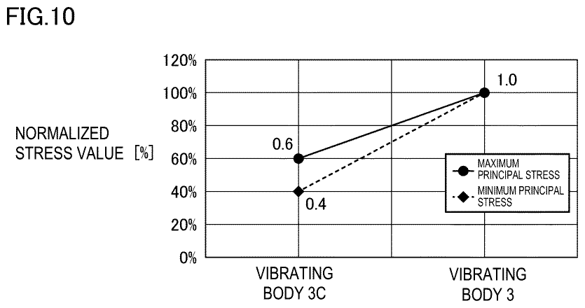

The column 35C is formed in the cantilever shape, which makes it possible to reduce a stress applied to the column 35C when the outermost layer lens 1 is vibrated. Therefore, the vibrating body 3C exhibits improved reliability in mechanical strength with the column 35C formed in the cantilever shape. FIG. 10 is a graph illustrating a comparison of stresses between the vibrating body 3 according to an aspect and the vibrating body 3C according to an aspect. FIG. 10 shows the results of comparison between the stresses generated per unit displacement amount of the vibrating body 3 having the columns 35 formed in the U shape and the vibrating body 3C having the columns 35C formed in the cantilever shape.

As illustrated in FIG. 10, the vibrating body 3C having the columns 35C formed in the cantilever shape has maximum and minimum principal stresses reduced to substantially half of those of the vibrating body 3 having the columns 35 formed in the U shape. The maximum and minimum principal stresses can be reduced similarly even when the columns 35C are formed in a meander shape by increasing the number of folded portions, instead of the cantilever shape.

As described above, the plurality of groove portions 30 each having the horizontally-laid Y shape are formed in the side surface of the vibrating body 3 in the optical device 10 according to an aspect, and as described above, the plurality of groove portions 30C each having the stepped shape are formed in the side surface of the vibrating body 3C in the optical device 10 according to another aspect. However, the shape of grooves formed in the side surface of the vibrating body is not limited to the horizontally-laid Y shape or the stepped shape. Hereinafter, modifications of the shape of grooves formed in the side surface of the vibrating body will be described.

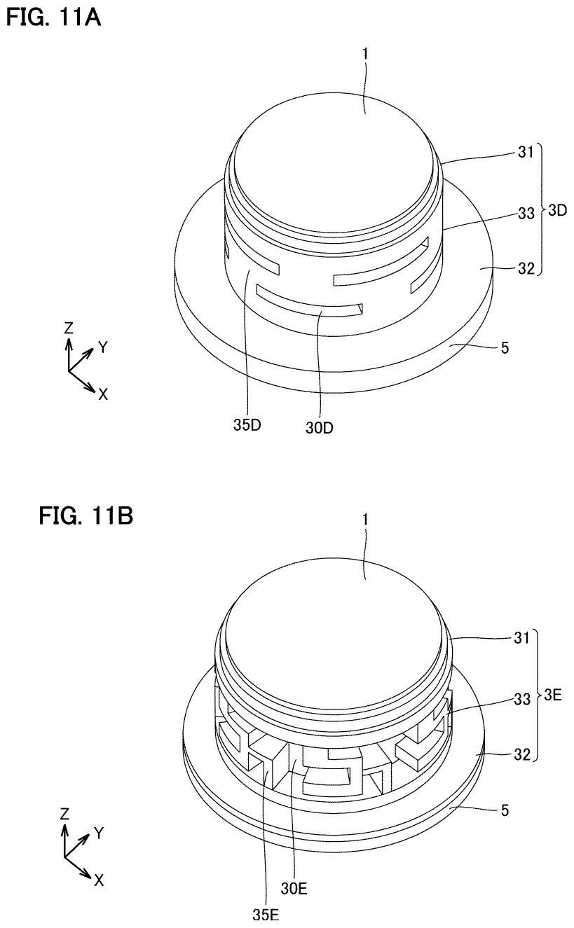

FIG. 11A and FIG. 11B are a schematic view of a vibrating body according to a first modification. FIG. 11A illustrates a vibrating body 3D in which a plurality of groove portions 30D each having a rectangular parallelepiped shape are formed in a side surface. The groove portion 30D has the rectangular parallelepiped shape as shown in FIG. 11A, and has a shape which is line-symmetrical with respect to the radial direction of the vibrating body 3D and point-symmetrical. The portions of the supporting portion 33 left by forming the groove portions 30D serve as a plurality of columns 35D which connect the connecting portion 31 and the vibrating portion 32. The columns 35D function as a spring which vibrates the outermost layer lens 1 in the Z direction. The groove portion 30D is not limited to a cavity but may be a concave portion which does not penetrate the supporting portion 33.

FIG. 11B illustrates a vibrating body 3E in which a plurality of groove portions 30E having a complicated shape in which a U shape and a cantilever shape are combined are formed in a side surface. The groove portion 30E is formed such that one end portion thereof is in contact with the connecting portion 31 and the other end portion thereof is in contact with the vibrating portion 32. The portions of the supporting portion 33 left by forming the groove portions 30E serve as a plurality of columns 35E which connect the connecting portion 31 and the vibrating portion 32. The columns 35E function as a spring which vibrates the outermost layer lens 1 in the Z direction. The groove portion 30E is not limited to a cavity but may be a concave portion which does not penetrate the supporting portion 33.

Note, the optical devices 10 having the respective vibrating bodies 3D and 3E and the imaging units 100 including the respective optical devices 10 have the same configurations as those described above, and therefore, the same configurations will be described with the same reference characters and the detailed description thereof will not be repeated.

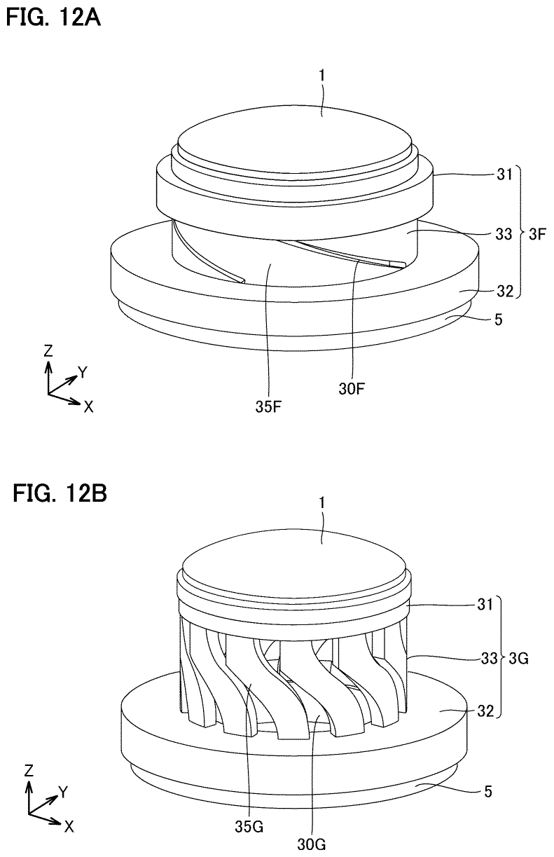

FIG. 12A and FIG. 12B are a schematic view of a vibrating body according to a second modification. FIG. 12A illustrates a vibrating body 3F in which a plurality of groove portions 30F each having a slit shape are formed in a side surface. The groove portion 30F has the slit shape as shown in FIG. 12A, and has a point-symmetrical shape. The groove portion 30F is formed such that one end portion thereof is in contact with the connecting portion 31 and the other end portion thereof is in contact with the vibrating portion 32. The portions of the supporting portion 33 left by forming the groove portions 30F serve as a plurality of columns 35F which connect the connecting portion 31 and the vibrating portion 32. The columns 35F function as a spring which vibrates the outermost layer lens 1 in the Z direction. The groove portion 30F is not limited to a cavity but may be a concave portion which does not penetrate the supporting portion 33.

FIG. 12B illustrates a vibrating body 3G in which a plurality of groove portions 30G each having a wave shape are formed in a side surface. The groove portion 30G has the wave shape as shown in FIG. 12B, and has a point-symmetrical shape. The groove portion 30G is formed such that one end portion thereof is in contact with the connecting portion 31 and the other end portion thereof is in contact with the vibrating portion 32. The portions of the supporting portion 33 left by forming the groove portions 30G serve as a plurality of columns 35G which connect the connecting portion 31 and the vibrating portion 32. The columns 35G function as a spring which vibrates the outermost layer lens 1 in the Z direction. The groove portion 30G is not limited to a cavity but may be a concave portion which does not penetrate the supporting portion 33.

Note, the optical devices 10 having the respective vibrating bodies 3F and 3G and the imaging units 100 including the respective optical devices 10 have the same configurations as those described above, and therefore, the same configurations will be described with the same reference characters and the detailed description thereof will not be repeated.

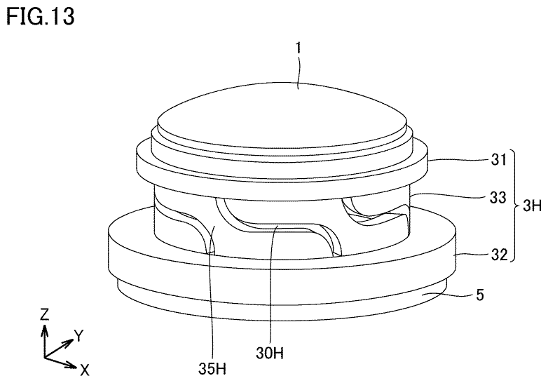

FIG. 13 is a schematic view of a vibrating body according to a third modification. FIG. 13 illustrates a vibrating body 3H in which a plurality of groove portions 30H each having an S shape are formed in a side surface. The groove portion 30H has the S shape as shown in FIG. 13, and has a point-symmetrical shape. The groove portion 30H is formed such that one end portion thereof is in contact with the connecting portion 31 and the other end portion thereof is in contact with the vibrating portion 32. The portions of the supporting portion 33 left by forming the groove portions 30H serve as a plurality of columns 35H which connect the connecting portion 31 and the vibrating portion 32. The columns 35H function as a spring which vibrates the outermost layer lens 1 in the Z direction. The groove portion 30H is not limited to a cavity but may be a concave portion which does not penetrate the supporting portion 33. Note, the optical device 10 having the vibrating body 3H and the imaging unit 100 including the optical device 10 have the same configurations as those described above, and therefore, the same configurations will be described with the same reference characters and the detailed description thereof will not be repeated.

The imaging unit according to the above-described aspects may include a camera, a LiDAR, a Radar, and the like. In addition, a plurality of imaging units may be arranged side by side.

The imaging unit according to the above-described aspects is not limited to an imaging unit provided in a vehicle but can be similarly applied as any imaging unit that includes an optical device and an imaging element, which is arranged such that a light transmitting body is in a viewing direction thereof, and that needs to remove foreign matters on a light transmitting body.

The aspects disclosed herein are to be considered in all respects as illustrative and not restrictive. The scope of the present disclosure is defined by the appended claims, rather than the foregoing description, and is intended to include any alterations within the scope and meaning equivalent to the appended claims.

In general, the description of the aspects disclosed should be considered as being illustrative in all respects and not being restrictive. The scope of the present disclosure is shown by the claims rather than by the above description and is intended to include meanings equivalent to the claims and all changes in the scope. While preferred aspects of the invention have been described above, it is to be understood that variations and modifications will be apparent to those skilled in the art without departing from the scope and spirit of the invention.

### DESCRIPTION OF REFERENCE SYMBOLS

1 outermost layer lens
2 housing
3, 3A to 3H vibrating body
4 inner layer lens
5 piezoelectric element
6 imaging element
7 circuit board
8 case
10 optical device
20 imaging device
30, 30A to 30H groove portion
31 connecting portion
32 vibrating portion
33 supporting portion
35, 35C to 35H column
36 bottom surface
100 imaging unit

1. An optical device comprising:
a light transmitting body configured to transmit light within a predetermined wavelength;
a housing configured to hold the light transmitting body;
a vibrating body in contact with the light transmitting body and held by the housing; and
a piezoelectric element provided on the vibrating body and configured to vibrate the vibrating body;
wherein the vibrating body is a tubular body and comprising a shape with a plurality of groove portions in a third portion, the third portion connecting a first portion which is in contact with the light transmitting body and a second portion on which the piezoelectric element is provided.

2. The optical device according to claim 1, wherein each of the plurality of groove portions is configured as a shape which is line-symmetrical with respect to a radial direction of the vibrating body.

3. The optical device according to claim 1, wherein the plurality of groove portions are formed such that a first end portion is in contact with the first portion and a second end portion is in contact with the second portion.

4. The optical device according to claim 1, wherein the third portion in which the plurality of groove portions are formed comprises a plurality of columns, each of the plurality of columns comprises a U shape and configured to connect to the first portion and the second portion.

5. The optical device according to claim 1, wherein the plurality of groove portions are formed at equal intervals in a circumferential direction.

6. The optical device according to claim 1, wherein a shape of each of the plurality of groove portions is a point-symmetrical shape.

7. The optical device according to claim 1, wherein the third portion wherein the plurality of groove portions are formed comprises a plurality of columns, each of the plurality of columns comprises a cantilever or meander shape and configured to connect the first portion and the second portion.

8. The optical device according to claim 1, wherein the plurality of groove portions are cavities penetrating in a radial direction of the tubular body.

9. The optical device according to claim 1, wherein at least one of the first portion, the second portion, or the third portion are integrally formed in the vibrating body.

10. The optical device according to claim 1, wherein the first portion, the second portion, and the third portion are integrally formed in the vibrating body.

11. An imaging unit comprising:
a light transmitting body configured to transmit light within a predetermined wavelength;
a housing configured to hold the light transmitting body;
a vibrating body in contact with the light transmitting body and held by the housing;
a piezoelectric element provided on the vibrating body and configured to vibrate the vibrating body; and
an imaging element arranged wherein the light transmitting body is in a viewing direction thereof;
wherein the vibrating body is a tubular body and comprising a shape with a plurality of groove portions in a third portion, the third portion connecting a first portion which is in contact with the light transmitting body and a second portion on which the piezoelectric element is provided.

12. The imaging unit according to claim 11, wherein each of the plurality of groove portions is configured as a shape which is line-symmetrical with respect to a radial direction of the vibrating body.

13. The imaging unit according to claim 11, wherein the plurality of groove portions are formed such that a first end portion is in contact with the first portion and a second end portion is in contact with the second portion.

14. The imaging unit according to claim 11, wherein the third portion in which the plurality of groove portions are formed comprises a plurality of columns, each of the plurality of columns comprises a U shape and configured to connect to the first portion and the second portion.

15. The imaging unit according to claim 11, wherein the plurality of groove portions are formed at equal intervals in a circumferential direction.

16. The imaging unit according to claim 11, wherein a shape of each of the plurality of groove portions is a point-symmetrical shape.

17. The imaging unit according to claim 11, wherein the third portion wherein the plurality of groove portions are formed comprises a plurality of columns, each of the plurality of columns comprises a cantilever or meander shape and configured to connect the first portion and the second portion.

18. The imaging unit according to claim 11, wherein the plurality of groove portions are cavities penetrating in a radial direction of the tubular body.

19. The imaging unit according to claim 11, wherein at least one of the first portion, the second portion, or the third portion are integrally formed in the vibrating body.

20. The imaging unit according to claim 11, wherein the first portion, the second portion, and the third portion are integrally formed in the vibrating body.
